(19) United States
(12) Patent Application Publication
(10) Pub. No.: US 2016/0313677 A1
(43) Pub. Date: Oct. 27, 2016

(54) BELT FEEDING DEVICE FOR IMAGE FORMING APPARATUS AND IMAGE FORMING APPARATUS

(71) Applicant: CANON KABUSHIKI KAISHA, Tokyo (JP)

(72) Inventor: Kiyoshi Oyama, Tokyo (JP)

(21) Appl. No.: 15/134,606

(22) Filed: Apr. 21, 2016

(30) Foreign Application Priority Data
Apr. 22, 2015 (JP) 2015-087961

(51) Int. Cl. G03G 15/01

(52) U.S. Cl. CPC G03G 15/1605; G03G 15/6529

(57) ABSTRACT

A belt feeding device includes a movable endless belt including a preventing guide provided through one-full circumference at each of end portions of the belt with respect to a widthwise direction perpendicular to a movement direction of the belt, and includes a plurality of rotatable rollers including a driving roller and a tension roller. The driving roller moves the belt by being rotationally driven about a rotational axis of which direction is fixed, and includes a tapered portion, at each of end portions thereof with respect to a rotational axis direction, which narrows in diameter from a central portion toward the end portion with respect to the rotational axis direction and which contacts the preventing guide. The tension roller rotates about a swingable rotational axis and a length of the tension roller is such that the belt during traveling is prevented from contacting the preventing guide.

### FIELD OF THE INVENTION AND RELATED ART

The present invention relates to a belt feeding device for use with an image forming apparatus, of an electrophotographic type or an electrostatic recording type, such as a copying machine, a printer or a facsimile machine.

Conventionally, for example, in the image forming apparatus of the electrophotographic type or the electrostatic recording type, a belt feeding device including an endless belt supported from an inner peripheral surface side by a plurality of supporting rollers. The belt is used as a feeding member for carrying and feeding a toner image or carrying and feeding a transfer material on which the toner image is formed. As the feeding member for carrying and feeding the toner image, a belt-shaped electrophotographic photosensitive member (photosensitive belt), an intermediary transfer member (intermediary transfer belt) for carrying the toner image in order to transfer the toner image from the photosensitive member onto the transfer material, and the like member are used. Further, as the feeding member for carrying and feeding the transfer material on which the toner image is formed, a transfer material feeding member (transfer material feeding belt) for carrying and feeding the transfer material onto which the toner image is transferred from the photosensitive member is used.

In such a belt feeding device, it is desired that shift (lateral shift or deviation) of the belt generating during drive of the belt is prevented. Here, the shift of the belt refers to movement of the belt in a widthwise direction perpendicular to a feeding direction of the belt.

In order to prevent the shift of the belt, the following constitution has been known. The belt is provided at an inner peripheral surface thereof with ribs as a preventing guide, and of a plurality of rollers supporting the belt, at least one is constituted as a preventing contactable to inside surfaces of the ribs. In this constitution, the inside surfaces of the ribs abut against end surfaces of the preventing roller, so that the shift of the belt is prevented.

Particularly, Japanese Laid-Open Utility Model Application Sho 63-76867 discloses that a preventing roller is provided at end portions thereof with respect to a rotational axis direction with tapered surfaces as a preventing portion. In this constitution, in a process in which a belt is wound about the preventing roller, inside surfaces of ribs slide on the tapered surfaces in a rotation center direction of the preventing roller. At this time, contact between the rib and the tapered surface is a line contact between an edge of the rib and the tapered surface, so that the belt can easily slide, and therefore the rib does not readily run on a portion (belt stretching portion) where the preventing roller contacts an inner peripheral surface of the belt. However, in this constitution, when the belt is driven for a long time while always sliding on the tapered surface at the rib portion, a property of at least one of the rib and the tapered surface changes, so that, a frictional force increases in some cases. Then, running of the rib on the belt stretching portion of the preventing roller generates in some cases.

Japanese laid-Open Patent Application Hei 5-303314 discloses the following constitution. A tension roller for imparting tension to a belt by urging the belt from an inner peripheral surface side toward an outer peripheral surface side of the belt is provided at end portions thereof with tapered surfaces each having a gently set angle. Then, the ribs are run on the tapered surfaces and the tension roller is inclined, so that a state of the laterally shifted belt is returned to a normal state. In this constitution, slide of inside surfaces of the ribs on the tapered surfaces is suppressed, and therefore the increase in frictional force due to the above-described change in property is suppressed, so that a degree of a risk of running of the rib on the belt stretching portion of the tension roller due to the drive of the belt for a long time decreases.

However, in the constitution in which the shift of the belt is prevented by providing the tapered surfaces at the end portions of the tension roller with respect to the rotational axis direction, there was the following problem.

The tension roller is, in general, urged uniformly with respect to a widthwise direction of the belt by being urged at the end portions thereof with respect to the widthwise direction of the belt by springs or the like as urging means. Accordingly, when the rib runs on the tapered surface on one end portion side of the belt with respect to the widthwise direction, the end portion of the tension roller on the running-on side moves from the outer peripheral surface side toward the inner peripheral surface side, so that the tension roller inclines. By using this inclination, the shift of the belt is returned, but at the same time, by this inclination, a close contact property between the tension roller and the belt is weakened, so that on the running-on side of the belt with respect to the widthwise direction, floating of the belt from the tension roller generates in some cases. Then, a belt retaining force by the tension roller is weakened, so that waving generates on a traveling surface of the belt in some cases.

As described above, the belt is used as the intermediary transfer belt for carrying and feeding the toner image transferred thereon and then for transferring the toner image onto the transfer material or the transfer material feeding belt for transferring the toner image onto the transfer material while carrying and feeding the transfer material. Then, for example, when the belt causes waving in a step of transferring the toner image onto the belt or a step of transferring the toner image onto the transfer material carried on the belt, an image defect such as transfer omission generates in some cases. Also in the case where the belt is used as the photosensitive belt, when the waving generates, a similar problem occurs in some cases in a transfer step or the like of transferring the toner image onto a transfer receiving member such as the transfer material.

### SUMMARY OF THE INVENTION

According to an aspect of the present invention, there is provided a belt feeding device for an image forming apparatus, comprising: a movable endless belt, including a preventing guide, configured to carry and feed a toner image or configured to carry and feed a recording material on which the toner image is formed, wherein the preventing guide is provided through one-full circumference at each of end portions of the belt with respect to a widthwise direction perpendicular to a movement direction of the belt, and a plurality of rotatable rollers, including a driving roller and a tension roller, configured to stretch the belt from an inner peripheral surface side, wherein the driving roller moves the belt by being rotationally driven about a rotational axis of which direction is fixed, and includes a tapered portion, at each of end portions thereof with respect to a rotational axis direction, which narrows in diameter from a central portion toward the end portion with respect to the rotational axis direction and which contacts the preventing guide, and wherein the tension roller rotates about a swingable rotational axis and urges the belt from the inner peripheral surface side toward an outer peripheral surface side, and a length of the tension roller is such that the belt during traveling is prevented from contacting the preventing guide.

According to another aspect of the present invention, there is provided an image forming apparatus comprising: a toner image forming unit configured to form a toner image; a movable endless belt, including a preventing guide, which is a feeding member configured to carry and feed the toner image formed by the toner image forming unit or configured to carry and feed a recording material on which the toner image is formed by the toner image forming unit, wherein the preventing guide is provided through one-full circumference at each of end portions of the belt with respect to a widthwise direction perpendicular to a movement direction of the belt, and a plurality of rotatable rollers, including a driving roller and a tension roller, configured to stretch the belt from an inner peripheral surface side, wherein the driving roller moves the belt by being rotationally driven about a rotational axis of which direction is fixed, and includes a tapered portion, at each of end portions thereof with respect to a rotational axis direction, which narrows in diameter from a central portion toward the end portion with respect to the rotational axis direction and which contacts the preventing guide, and wherein the tension roller rotates about a swingable rotational axis and urges the belt from the inner peripheral surface side toward an outer peripheral surface side, and a length of the tension roller is such that the belt during traveling is prevented from contacting the preventing guide.

Further features of the present invention will become apparent from the following description of exemplary embodiments with reference to the attached drawings.

### BRIEF DESCRIPTION OF THE DRAWINGS

FIG. 1 is a schematic sectional view of an image forming apparatus according to Embodiment 1.

FIG. 2 is a schematic sectional view of an intermediary transfer member unit in Embodiment 1.

FIG. 3 is a schematic sectional view of a periphery of a driving roller for an intermediary transfer belt in Embodiment 1.

FIG. 4 is a perspective view of a simulation model in Embodiment 1.

In FIG. 5, (a) to (c) are schematic views showing a calculation result of the simulation model in Embodiment 1.

In FIG. 6, (a) to (f) are schematic views showing calculation results of the simulation model in Embodiment 1.

In FIG. 7, (a) to (c) are schematic views for illustrating a mechanism in Embodiment 1.

FIG. 8 is a perspective view of a simulation model in a conventional example.

FIG. 9 is a perspective view showing a calculation result of a generation status of waving in the simulation model in the conventional example.

FIG. 10 is a perspective view showing a calculation result of a generation status of waving in the simulation model in Embodiment 1.

FIG. 11 is a graph showing states of the waving in the conventional example and Embodiment 1.

In FIG. 12, (a) and (b) are illustrations each showing a calculation result of a simulation model showing a contact state between a belt and a roller, in which (a) shows the calculation result in the conventional example, and (b) shows the calculation result in Embodiment 1.

In FIG. 13, (a) to (c) are schematic sectional views each showing a periphery of an end portion of a driving roller in Embodiment 2.

### DESCRIPTION OF THE EMBODIMENTS

A belt feeding device for an image forming apparatus according to the present invention and the image forming apparatus will be described with reference to the drawings.

### Embodiment 1

### 1. General Structure and Operation of Image Forming Apparatus

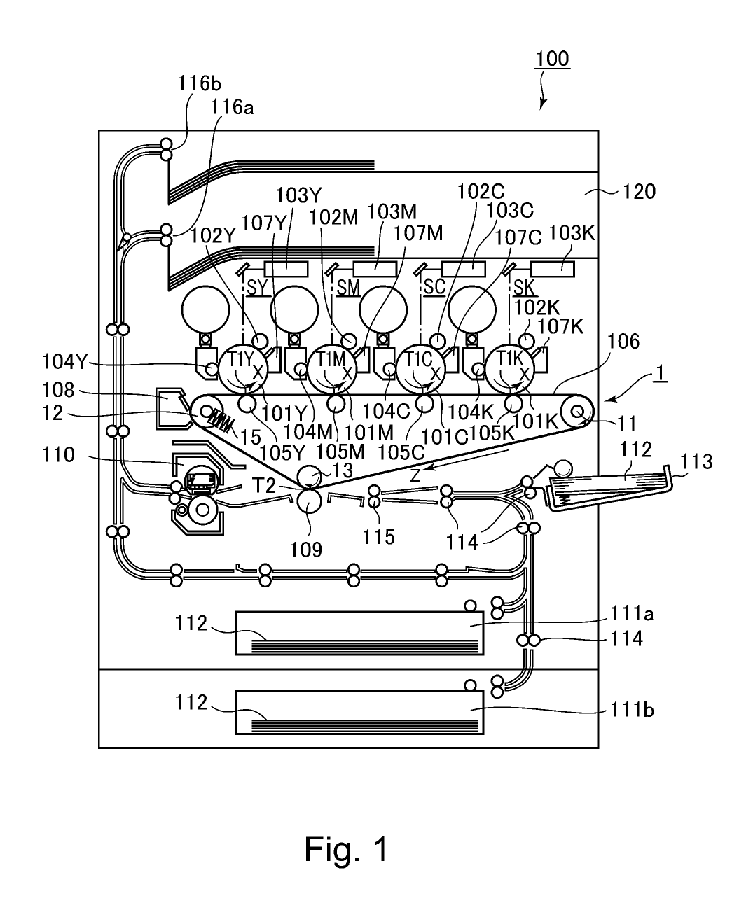

FIG. 1 is a schematic sectional view of an image forming apparatus 100 in this embodiment according to the present invention.

The image forming apparatus 100 in this embodiment is a tandem-type color digital printer which is capable of forming a full-color image using an electrophotographic type and which employs an intermediary transfer type.

The image forming apparatus 100 includes, as a plurality of image forming portions (stations), first to fourth image forming portions (stations) SY, SM, SC and SK for forming images of yellow (Y), magenta (M), cyan (C) and black (K), respectively. In this embodiment, constitutions and operations of the image forming portions SY, SM, SC and SK are substantially the same except that colors of toners used in a developing step are different from each other. Accordingly, in the following, in the case where particular distinction is not required, suffixes Y, M, C and K for representing elements for associated colors, respectively, are omitted, and the elements will be collectively described.

At the image forming portion S, a photosensitive drum 101 which is a rotatable drum-shaped (cylindrical) electrophotographic photosensitive member as an image bearing member is provided. The photosensitive drum 101 is rotationally driven in an arrow X direction in FIG. 1. At a periphery of the photosensitive drum 101, the following devices are provided in the listed order along a rotational direction of the photosensitive drum 101. First, a charging roller 102 which is a roller-shaped charging member as a charging means is disposed. Next, an exposure device (laser scanner) 103 as an exposure means is disposed. Next, a developing device 104 as a developing means is disposed. Next, a primary transfer roller 105 which is a roller-shaped primary transfer member as a primary transfer means. Next, a drum cleaner 107 as a photosensitive member cleaning means is disposed.

A surface of the rotating photosensitive drum 101 is electrically charged substantially uniformly by the charging roller 102. The charged surface of the photosensitive drum 101 is subjected to scanning exposure to light by the exposure device 103. Into the exposure device 103, an image signal for a color component corresponding to an associated image forming portion S, and the surface of the photosensitive drum 101 is irradiated with laser light depending on the first signal by the exposure device 103 to neutralize the electric charges, so that an electrostatic latent image (electrostatic image) is formed on the surface of the photosensitive drum 101. The electrostatic latent image is formed on the photosensitive drum 101 is developed with a toner, of the color corresponding to the associated image forming portion S, into a toner image by the developing device 104.

An intermediary transfer belt 106, as an intermediary transfer member constituted by an endless belt, which is included in an intermediary transfer member unit 1 described later is provided so as to oppose the respective photosensitive drums 101. The intermediary transfer belt 106 is rotationally driven (fed) in an arrow Z direction in FIG. 1. The above-described primary transfer rollers 105 are provided opposed to the photosensitive drums 101 via the intermediary transfer belt 106. The toner images formed on the photosensitive drums 101 are electrostatically transferred (primary-transferred) onto the rotating intermediary transfer belt 106 by the action of the primary transfer rollers 105. For example, during full-color image formation, the toner images of the colors of yellow, magenta, cyan and black formed on the photosensitive drums 101 are successively transferred superposedly onto the intermediary transfer belt 106. As a result, the toner images for a full-color image are formed on the intermediary transfer belt 106. The toner (primary transfer residual toner) remaining on the photosensitive drum 101 after the primary transfer step is removed and collected from the photosensitive drum 101 by the drum cleaner 107.

On the other hand, a transfer material (sheet) 112 such as recording paper fed from either one of transfer material cassettes 111a and 111b and a manual feeding portion 113 is fed by feeding rollers 114 toward a registration roller pair 115. The transfer material 112 abuts against the registration roller pair 115 in rest to form a loop, and thereafter rotation of the registration roller pair 115 is started in synchronism with the toner images on the intermediary transfer belt 106. Then, the toner images on the intermediary transfer belt 6 are electrostatically transferred (secondary-transferred) onto the transfer material 112 by the action of a secondary transfer roller (outer secondary transfer roller) 109 which is a roller-shaped secondary transfer member as a secondary transfer means. The toner (secondary transfer residual toner) remaining on the intermediary transfer belt 106 after the secondary transfer step is removed and collected from the intermediary transfer belt 106 by a belt cleaner 108, as an intermediary transfer member cleaning means, included in the intermediary transfer member unit 1 described later.

The transfer material 112 on which the toner images are transferred is heated and pressed by a fixing device 110 as a fixing means, so that the toner images are fixed thereon. Thereafter, the transfer material 112 is discharged to an outside of an apparatus main assembly 120 of the image forming apparatus 100 through either one of discharging portions 116a and 116b.

In this embodiment, at each of the image forming portions S, by the photosensitive drum 1, the charging roller 102, the exposure device 103, the developing device 104, the primary transfer roller and the like, a toner image forming means for forming the toner image on the intermediary transfer belt 106 is constituted.

### 2. Intermediary Transfer Belt

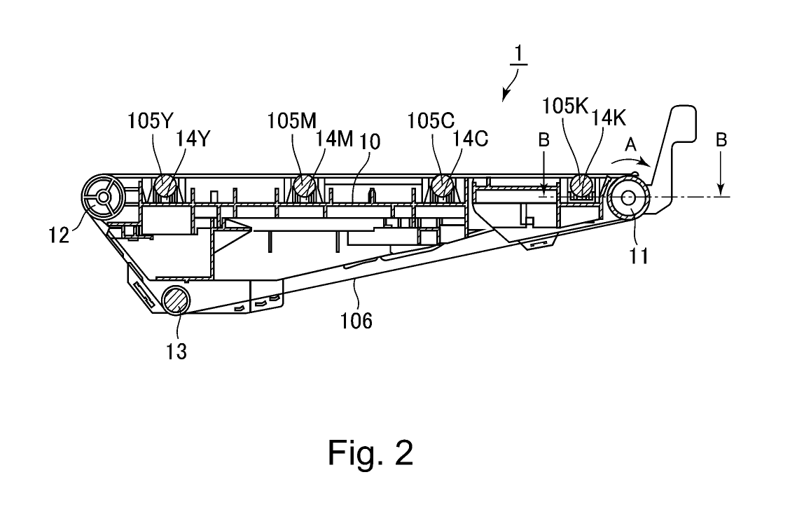

FIG. 2 is a schematic sectional view of the intermediary transfer member unit 1 as a belt feeding device in this embodiment. In this embodiment, the intermediary transfer member unit 1 is detachably mountable to the apparatus main assembly 120 of the image forming apparatus 100.

The intermediary transfer member unit 1 includes a supporting frame 10 as a supporting member. The supporting frame 10 supports, as a plurality of rollers (supporting rollers) for supporting the intermediary transfer belt 106 from an inner peripheral surface side, a driving roller 11, a tension roller 12 and a secondary transfer opposite roller (inner secondary transfer roller) 13. Further, the intermediary transfer belt 106 constituted by the endless belt as the intermediary transfer member is wound around these rollers. The intermediary transfer belt 106 is an example of a feeding member for carrying and feeding the toner images.

As described specifically later, the driving roller 11 is supported by the supporting frame 10 via a bearing so as to be rotatable around a rotational axis disposed at a fixed position. Also the secondary transfer opposite roller 13 is supported by the supporting frame 10 via a bearing so as to rotatable at a fixed position. On the other hand, the tension roller 12 is supported by the supporting frame 10 via a bearing so as to be rotatable around a swingable rotational axis. The tension roller 12 is urged, at a belt of the bearing at each of end portions with respect to a rotational axis direction, by a spring 15 (FIG. 1) as an urging means. The spring 15 urges the tension roller 12 from the inner peripheral surface side toward an outer peripheral surface side of the belt 106 at each of the end portions of the tension roller 12 with respect to the rotational axis direction. As a result, the tension roller 12 urges the intermediary transfer belt 106 from the inner peripheral surface side toward the outer peripheral surface side of the intermediary transfer belt 106, so that a predetermined tension is imparted to the intermediary transfer belt 106. With respect to the tension roller 12, each of the bearings at the end portions thereof with respect to the rotational axis direction moves, so that the rotational axis is swingable.

Further, each of the primary transfer rollers 105 is supported by the supporting frame 10 via the bearings so as to be rotatable. Each primary transfer roller 105 is urged to be pressed against the inner peripheral surface of the intermediary transfer belt 106 by being urged at positions of the bearings by springs 14 as urging means.

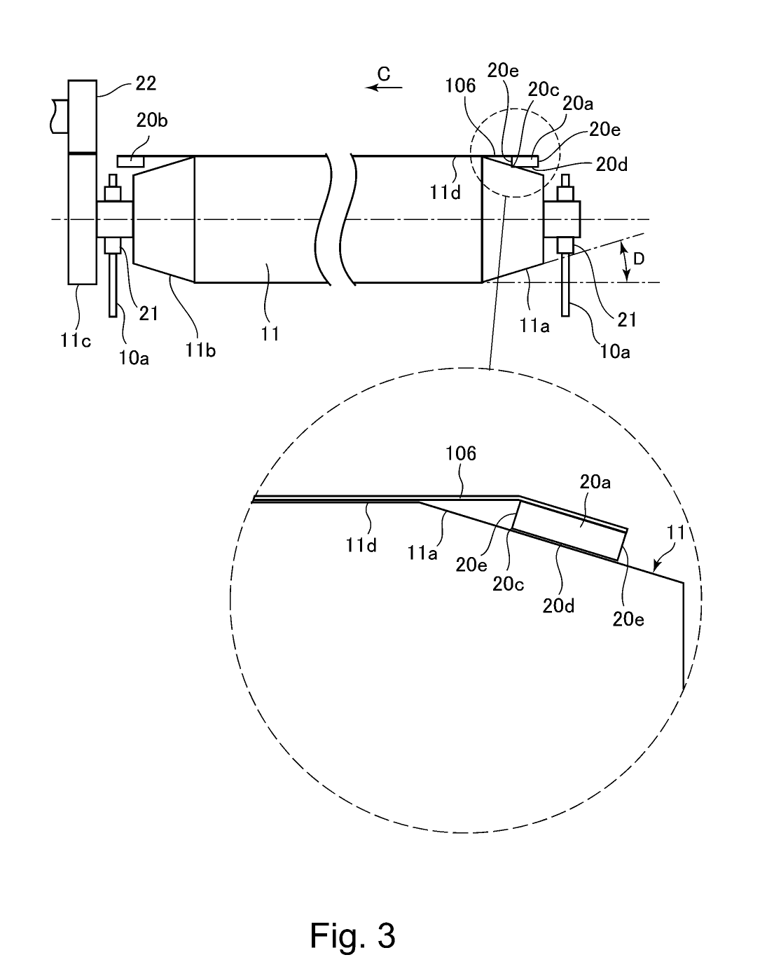

When the intermediary transfer member unit 1 is mounted in the apparatus main assembly 120 of the image forming apparatus 100, a driven gear 11c (FIG. 3) connected with one of the end portions of the driving roller 11 with respect to the rotational axis direction is connected with a driving system provided in the apparatus main assembly 120 side. Then, the driving roller 11 is rotationally driven in an arrow A direction in FIG. 2. When the driving roller 11 is rotated, the intermediary transfer belt 106 is traveled (rotated) by a rotational friction force. The tension roller 12 and the secondary transfer opposite roller 13 are rotated by the traveling of the intermediary transfer belt 106.

Further, when the intermediary transfer member unit 1 is mounted in the apparatus main assembly 120 of the image forming apparatus 100, the respective primary transfer rollers 105 are press-contacted to the intermediary transfer belt 106 toward the photosensitive drums 101. As a result, a primary transfer portion T1 (FIG. 1) where each of the photosensitive drums 1 and the intermediary transfer belt 106 are in contact with each other is formed. Then, each of the primary transfer rollers 105 is rotated by traveling of the intermediary transfer belt 106. Further, when the intermediary transfer member unit 1 is mounted in the apparatus main assembly 120, the secondary transfer roller 109 is press-contacted to the intermediary transfer belt 106 toward the secondary transfer opposite roller 13. As a result, a secondary transfer portion T2 (FIG. 1) where the intermediary transfer belt 106 and the secondary transfer roller 109 are in contact with each other is formed.

### 3. Prevention of Shift of Belt

Next, prevention of shift of the intermediary transfer belt 106 in this embodiment will be described.

### 3-1. Constitution

In this embodiment, the driving roller 11 also has a function as a preventing roller for preventing the shift of the belt 106. FIG. 3 is a sectional view specifically showing a constitution of a periphery of the driving roller 11 in cross-section B-B in FIG. 2.

The belt 106 is provided with ribs 20a, 20b as preventing guides for preventing the shift of the belt at an inner peripheral surface thereof at end portions with respect to a widthwise direction thereof. Each of the ribs 20a, 20b projects from the inner peripheral surface of the belt 106 and extends over full circumference of the belt 106 in this embodiment along a circumferential direction of the belt 106. Each of the ribs 20a, 20b is formed of a soft material such as a rubber or a plastic. Each of the ribs 20a, 20b is applied to the inner peripheral surface of the belt 106 by an adhesive, a double-side tape or the like. In this embodiment, each of the ribs 20a, 20b has an inner peripheral surface 20d disposed substantially parallel to the inner peripheral surface of the belt 106 and side surfaces 20e, 20e disposed substantially perpendicular to the inner peripheral surface of the belt 106. That is, in the case where the ribs 20a, 20b are not deformed by an external force (under no load), each of the ribs 20a, 20b has a rectangular shape in cross section along the widthwise direction of the belt 106. A surface opposite from the inner peripheral surface 20d of each of the ribs 20a, 20b is fixed to the inner peripheral surface of the belt 106.

A constitution of the driving roller 11 relating to prevention of the shift of the belt 106 in the neighborhood of the end portions of the driving roller 11 is substantially line-symmetrical. The driving roller 11 is rotatably supported by a side portion 10a of a supporting frame 10 via a bearing 21 at each of the end portions with respect to a rotational axis direction thereof. A driven gear 11c is connected with the driving roller 11 at one of the end portions with respect to the rotational axis direction. A driving gear 22 provided on the apparatus main assembly 120 side engages with the driven gear 11c, and a driving force (drive) is transmitted from a driving source provided on the apparatus main assembly 120 side to the driving roller 11. Then, the ribs 20a, 20b are contactable to the end portions, respectively, of the driving roller 11 with respect to the rotational axis direction, and preventing portions (tapered surfaces) 11a, 11b each having such a tapered shape that a diameter decreases from a central portion side toward an end portion side with respect to the rotational axis direction of the driving roller 11 are provided. In this embodiment, a maximum outer diameter of each of the preventing portions 11a, 11b is substantially the same as an outer diameter of a portion (belt stretching portion) 11d of the driving roller 11 contacting the inner peripheral surface of the belt 106. In this embodiment, the preventing portions 11a, 11b rotate coaxially and integrally with the driving roller 11. Incidentally, the driving portions 11a, 11b may also be separate members (preventing members) from the driving roller 11 and may also be rotatable independently of the driving roller 11.

During traveling of the belt 106, for example, in the case where the belt 106 shifts in an arrow C direction (toward a left side) in FIG. 3, an edge 20c (on a widthwise central portion side of the belt 106) and the inner peripheral surface 20d of the right side rib 20a in FIG. 3 and the preventing portion 11a contact each other. As a result, movement of the belt 106 in the widthwise direction is stopped, so that the (lateral) shift of the belt 106 is prevented. In this way, the inner peripheral surfaces 20d, of the ribs 20a, 20b, which are surfaces crossing a normal to the outer peripheral surface of the belt 106 contact the preventing portions 11a, 11b, respectively. This is because as described specifically later, the preventing portions 11a, 11b are provided to the driving roller 11 and tension is imparted to the belt 106 by the tension roller 12 separately.

Further, during the traveling of the belt 106, of the plurality of rollers supporting the belt 106, the rollers other than the driving roller 11 are prevented from contacting the ribs 20a, 20b. That is, the tension roller 12, having a swingable rotational axis, which is the roller other than the driving roller 11 is in non-contact with the ribs 20a, 20b. This can be realized by such a manner that a length of the roller, with respect to the rotational axis direction, other than the driving roller 11 is made not more than a length of the driving roller 11 at a portion other than the preventing portions 11a, 11b with respect to the rotational axis direction.

Further, in this embodiment, a predetermined angle D (formed between an extension line of the portion (belt stretch portion) 11d, of the driving roller 11, contacting the belt 106 and the surface of each of the preventing portions 11a, 11b) at an inclined portion formed on each of the preventing portions (tapered surfaces) 11a, 11b was 15°. This angle D is not limitative, but may preferably be 10° or more and 30° or less, more preferably be 20° or less in order to prevent the shift of the belt 106 by a mechanism described specifically later. When the angle D is smaller than the above range, action of preventing the shift of the belt 106 is not readily exhibited. Further, when the angle D is larger than the above range, the ribs 20a, 20b contact the preventing portions 11a, 11b at the side surfaces and slide on the preventing portions 11a, 11b. As a result, there is an increasing risk such that the ribs 20a, 20b run on the belt stretching portion 11d of the driving roller 11 due to an increase in frictional force by a change in property of either one of the preventing portions 11a, 11b.

In this way, in this embodiment, the driving roller 11 is provided with the preventing portions 11a, 11b, and the rib 20a, 20b run on the preventing portions 11a, 11b, so that the shift of the belt 106 is prevented and thus a traveling position of the belt 106 with respect to the widthwise direction is automatically aligned. In this constitution, even when the ribs 20a, 20b run on the preventing portions 11a, 11b, floating of the belt 106 from the driving roller 11 is suppressed, so that waving of the belt 106 is suppressed. Accordingly, generation of the image defect such as the transfer omission as described above is suppressed. Further, in this embodiment, when the belt 106 shifts, the inner peripheral surfaces 20d of the ribs 20a, 20b contact the preventing portions 11a, 11b, so that a shifting force, with respect to an opposite direction, which resists therewith to eliminate the contact generates and thus the laterally shifted state of the belt 106 is returned to the normal (original) state. For that reason, compared with a constitution in which the shift of the belt 106 is prevented by contact of side surfaces (edges) of the ribs 20a, 20b with the tapered surfaces, a degree of wearing (abrasion) of the ribs 20a, 20b is small. Accordingly, a risk of running of the ribs 20a, 20b on the belt stretching portion 11d of the driving roller 11 decreases. A mechanism and an effect of preventing the shift of the belt 106 will be described in detail below.

### 3-2. Mechanism

Next, a simulation experiment showing action of preventing the shift of the belt 106 in this embodiment will be described. The simulation experiment was conducted using a general-purpose non-linear structural analysis software (“Abaqus”).

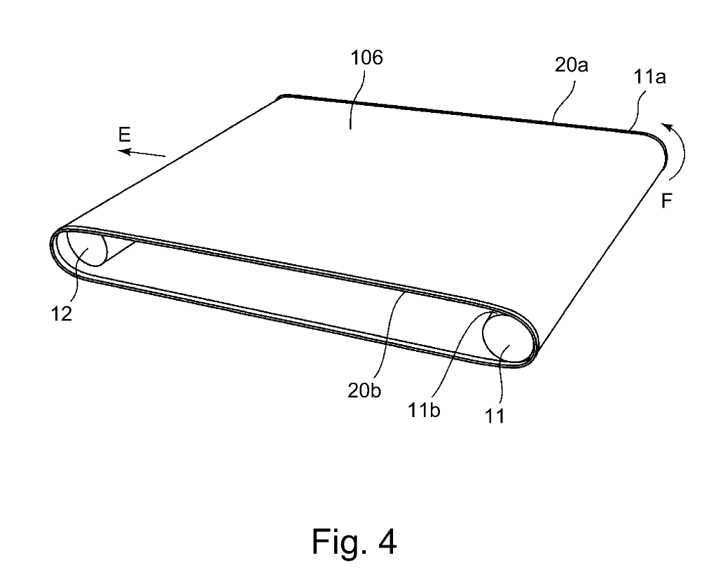

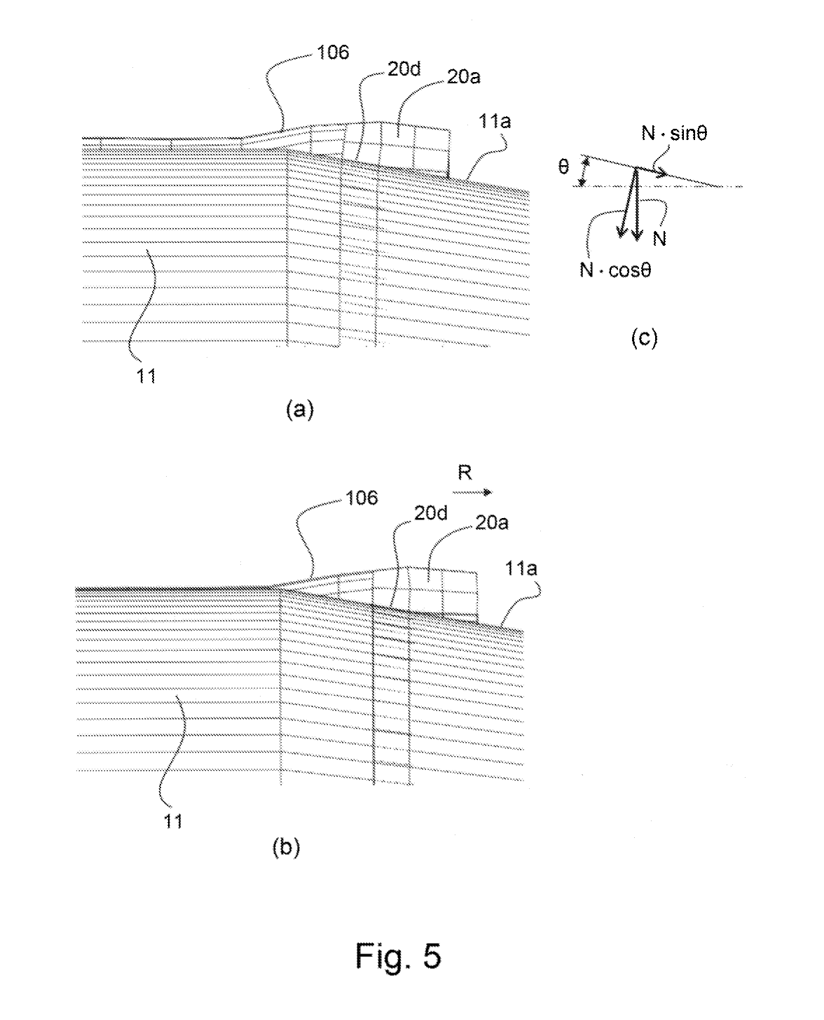

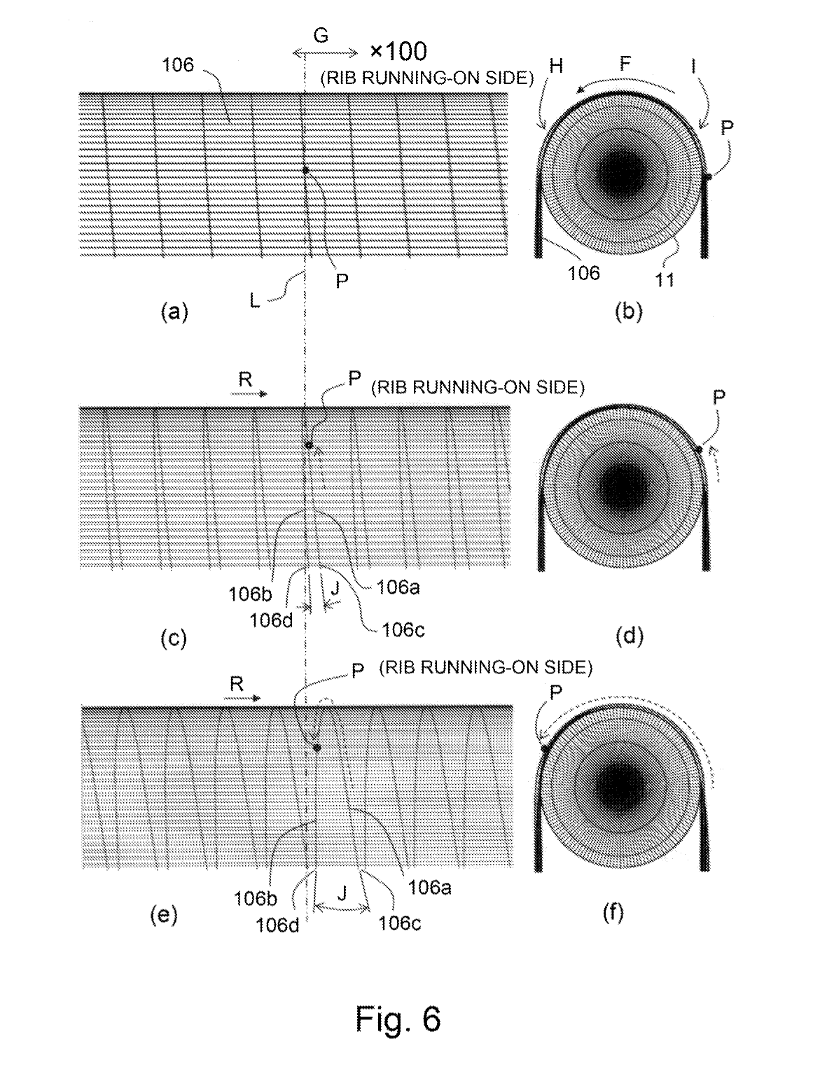

FIG. 4 shows a model for the simulation experiment. This model is downsized and simplified for shortening a calculation time. The belt 106 is stretched by the driving roller 11 and the tension roller 12. The tension roller 12 is urged in an arrow E direction in FIG. 9 by a spring (not shown) at each of end portions with respect to a rotational axis direction thereof, and imparts a predetermined contact force to a contact portion between the driving roller 11 and the belt 106. At this time, the ribs 20a, 20b are disposed similarly as the arrangement shown in FIG. 3. That is, the rear side rib 20a is in a state in which the rib 20a contacts and runs on the preventing portion 11a at the inner peripheral surface 20d thereof. On the other hand, the front side rib 20b in FIG. 4 does not contact the preventing portion 11b. In this state, the driving roller 11 is rotated in an arrow F direction in FIG. 4.

In FIG. 5, (a) and (b) are calculation results in the neighborhood of the rib 20a in cross section similar to that in FIG. 3, in which (a) shows a state before rotation of the driving roller 11, and (b) shows a state after the driving roller 11 is rotated by a predetermined distance. As shown in (a) and (b) of FIG. 5, the inner peripheral surface 20d of the rib 20a surface-contacts the preventing portion 11a by being urged against the preventing portion 11a by an urging force of the tension roller 12. Then, as shown in (b) of FIG. 5, after the driving roller 11 is rotated by the predetermined distance, the belt 106 moves in an arrow R direction. That is, it is understood that the belt 106 moves in a direction of eliminating running of the rib 20a on the preventing portion 11a and the lateral shift of the belt 106 is returned. A mechanism for preventing the shift of the belt 106 in this way will be described below.

In FIG. 6, each of (a), (c) and (e) shows a shape of the belt 106 as seen from the same direction as that in FIG. 5. In FIG. 6, (a) shows a state before rotation of the belt 106, and (c) and (e) show states of a change with time of the belt 106 during rotation in the listed order. Each of (a), (c) and (e) of FIG. 6 is shown with a magnification of 100 with respect to an arrow G direction, and a right side is an end portion side where the rib 20a runs on the preventing portion 11b with respect to the widthwise direction of the belt 106. In each of (a), (c) and (e) of FIG. 6, point P is a particular nodal point of a finite element model of the belt 106, and a position thereof moves together with rotation of the belt 106 in the order of (a), (c) and (e) of FIG. 6. Further, (b), (d) and (f) of FIG. 6 are right side views corresponding to (a), (c) and (e) of FIG. 6, respectively and show positions of the nodal point P on the belt 106. In (a), (c) and (e) of FIG. 6, the belt 106 is displayed in such a manner that the finite element model is shown in a lattice shape. For that reason, with respect to a traveling direction (arrow F direction) of the belt 106 wound about the driving roller 11, not only the shape on a downstream side (front side with respect to the direction of sight (arrow H side of (b) of FIG. 6) but also the shape on an upstream side (rear side with respect to the direction of sight (arrow I side of (b) of FIG. 6)) are shown.

In (a) of FIG. 6, it is understood that the lattices on the downstream side and the upstream side substantially overlap with each other (i.e., the lattices on the downstream side and the upstream side have the same shape). At this time, the nodal point P is, as shown in (b) of FIG. 6, on the upstream side of the driving roller 11 about which the belt 106 winds.

As shown in (c) of FIG. 6, when the belt 106 starts rotation in an arrow F direction, the nodal point P moves. At the same time, between the upstream side lattices and the downstream side lattices which coincide with each other before rotation, deviation generates between an upstream side circumferential direction line 106a and a downstream side circumferential direction line 106b.

As shown in (e) of FIG. 6, in a state in which the rotation of the belt 106 further advances and the nodal point P moves to the downstream state, the deviation between the upstream side circumferential direction line 106a and the downstream side circumferential direction line 106b increases.

A perpendicular line 1 is drawn at the position of the nodal point P and a state of the deviation will be observed. As shown in (c) and (e) of FIG. 6, an upstream portion 106c of the upstream side circumferential direction line 106a with respect to the traveling direction of the belt 106 moves in a direction (right side) in which the running of the rib 20a on the preventing portion 11a is eliminated. On the other hand, a downstream portion 106d of the downstream side circumferential direction line 106b with respect to the traveling direction of the belt 106 moves toward an opposite side to the side of the movement direction of the upstream portion 106c of the upstream side circumferential direction line 106a. As a result, a deviation angle J is formed between the upstream side circumferential direction line 106a and the downstream side circumferential direction line 106b. Further, at the same time, the nodal point P deviates from an original position toward the right side. Similarly, also the circumferential direction lines 106a, 106b move toward the right side as a whole. As a result, an entirety of the belt 106 starts to shift in an arrow R direction (right side), i.e., in a direction of eliminating the running of the rib 20a on the preventing portion 11a. Then, when a state subsequent to the state shown in (e) of FIG. 6 is calculated, the belt 106 shifts in the arrow R direction while maintaining the deviation angle J shown in (e) of FIG. 6 for some time, and thereafter the deviation angle J decreases again and correspondingly to this, also a shift amount of the belt 106 in the arrow R direction decreases.

Using (a), (b) and (c) of FIG. 7, correspondence of the deviation angle J with the shift amount and a shift direction of the belt 106 will be described. In FIG. 7, (a), (b) and (c) are schematic views for (a), (b) and (c) of FIG. 6, respectively.

In (a) of FIG. 7, the circumferential direction line 106a on the upstream (rear side with respect to the direction of sight) and the circumferential direction line 106b on the downstream side (front side with respect to the direction of sight) overlap with each other, so that a state in which the deviation angle J is zero is formed. Now, it is assumed that the upstream side circumferential direction line 106a and the downstream side circumferential direction line 106b maintain inclination thereof even when the belt 106 rotates. Then, how a point PU on the upstream side circumferential direction line 106a and a point PL at a top portion (angular position at substantially half of a winding angle range) of the downstream side circumferential direction line 106b are moved by the rotation of the belt 106 will be considered. Assuming that the belt 106 does not slide on the driving roller 11, the point PU is moved to a point PU′ and the point PL is moved to a point PL′ by the rotation of the driving roller 11. Correspondingly to this, assuming that the upstream side circumferential direction line 106a and the downstream side circumferential direction line 106b are moved, these circumferential direction lines 106a, 106b are moved to circumferential direction lines 106a′, 106b′, respectively. Assumed movement amounts of the upstream side circumferential direction line 106a and the downstream side circumferential direction line 106b are m and n, respectively. In the case where inclination of the upstream side circumferential direction line 106a and inclination of the downstream side circumferential direction line 106b are the same, a relationship between the assumed movement amounts m and n of the upstream side circumferential direction line 106a and the downstream side circumferential direction line 106b, respectively, is m=n. Further, the movement direction of the upstream side circumferential direction line 106a and the movement direction of the downstream side circumferential direction line 106b are opposite to each other. In actuality, the circumferential direction lines coincide with each other at the top portion (position of the point plurality) of winding of the belt 106 about the driving roller 11, and therefore the points PU, PL slide on the driving roller 11. When the right direction is positive, the shift amount of the belt 106 is m−n=m−m=0, so that the belt 106 remains at that position.

As shown in (b) of FIG. 7, it is assumed that the downstream side circumferential direction line 106b is in the same position as that in (a) of FIG. 7 and the upstream side circumferential direction line 106a shifts in the right side more than that in (a) of FIG. 7 and thus the deviation angle J is formed. In this case, the relationship between the assumed movement amounts m and n of the upstream side circumferential direction line 106a and the downstream side circumferential direction line 106b, respectively, is m>n. Further, the movement direction of the upstream side circumferential direction line 106a and the movement direction of the downstream side circumferential direction line 106b are opposite to each other. Accordingly, the shift amount of the belt 106 is m−n>0, so that the belt 106 shifts toward the right side.

Further, the case where the downstream side circumferential direction line 106b is inclined toward the side opposite to the side of the upstream side circumferential direction line 106a will be considered. In this case, n is positive, i.e., the movement direction of the downstream side circumferential direction line 106b is the right direction (which is the same direction as the movement direction of the upstream side circumferential direction line 106a. Accordingly, the shift amount of the belt 106 is m+n>m−n>0, so that the belt 106 largely shifts toward the right side more than the case of (b) of FIG. 7 and also the deviation angle J becomes larger than the deviation angle J in (b) of FIG. 7.

From the above, it is understood that when there is a deviation angle between the upstream side circumferential direction line 106a and the downstream side circumferential direction line 106b with respect to the traveling direction of the belt 106 wound about the driving roller 11, the belt 106 shifts in a deviation direction of the upstream side circumferential direction line 106a with the shift amount correspondingly to the deviation angle.

Next, the reason why the belt 106 shifts in the direction of eliminating the running of the rib 20a on the preventing portion 11a will be described. In FIG. 5, (c) is a schematic view showing directions of forces acting on the rib 20a. An inclination angle of the photosensitive drum (tapered portion) 11a is θ.

On the inner peripheral surface 20d which is a portion where the rib 20a surface-contacts the preventing portion 11a, a force N, toward a winding center (rotational axis of the driving roller 11) of the belt 106, which depends on an urging force by the tension roller 12 acts. Accordingly, a shifting force which is N×sin θ acts on the rib 20a in a descending direction (direction from a central portion side toward an end portion side of the driving roller 11 with respect to the rotational axis direction) of the preventing portion 11. When the driving roller 11 rotates, first, from the upstream side with respect to the traveling direction of the belt 106 wound about the driving roller 11, the rib 20a starts to shift (deviate) by this shifting force. Correspondingly to this, as described above using (c) of FIG. 6, the upstream side circumferential direction line 106a shifts toward the right side. The downstream side circumferential direction line 106b starts to shift with a delay in accordance with the rotation of the driving roller 11, and therefore between the upstream side circumferential direction line 106a and the develop circumferential direction line 106b, the deviation angle J formed by the shift of the upstream side circumferential direction line 106a toward the right side generates. By this deviation angle J, the belt 106 shifts toward the right side, i.e., in the direction of eliminating the running of the rib 20a on the preventing portion 11a. Further, the force N changes depending on a degree of the running of the rib 20a on the preventing portion 11a, so that the shifting force N×sin θ becomes small and also the deviation angle J becomes small. Finally, the shift of the belt 106 stops at a roller position. This action is true for also the left side constituted substantially line-symmetrically with the right side described above on the basis of a substantially center line of the belt 106 with respect to the widthwise direction. Accordingly, prevention of the shift of the belt 106 toward end portion directions with respect to the widthwise direction of the belt 106, i.e., automatic alignment of the traveling position of the belt 106 with respect to the widthwise direction, is made.

Incidentally, in this embodiment, as shown in FIG. 3, when the rib 20a contacts the preventing portion 11a on one side of the belt 106 with respect to the widthwise direction, on an opposite side, the rib 20b does not contact the preventing portion 11b. However, the present invention is not limited to such an embodiment, but the ribs 20a, 20b contact the preventing portions 11a, 11b, respectively, at the same time at the end portions of the belt 106 with respect to the widthwise direction. In this case, from a relationship in magnitude between the shifting forces generating in the opposite directions at the end portions of the belt 106 with respect to the widthwise direction, a total of the shifting forces and the shifting directions are determined, so that the deviation angle generates correspondingly thereto and thus the belt 106 shifts. Then, at a position where the shifting forces generating at the end portions of the belt 106 with respect to the widthwise direction are substantially equal to each other, the belt 106 is maintained. Accordingly, also in this case, it becomes possible to prevent the shift of the belt 106 similarly as in this embodiment. The ribs 20a, 20b disposed at the end portions with respect to the widthwise direction of the belt 106 may always run on the preventing portions 11a, 11b, respectively.

### 3-3. Effect

Next, a difference between the case where the driving roller 11 is provided with the preventing portions as in this embodiment and the case where the tension roller 12 is provided with the preventing portions as in a conventional example is compared by a simulation experiment.

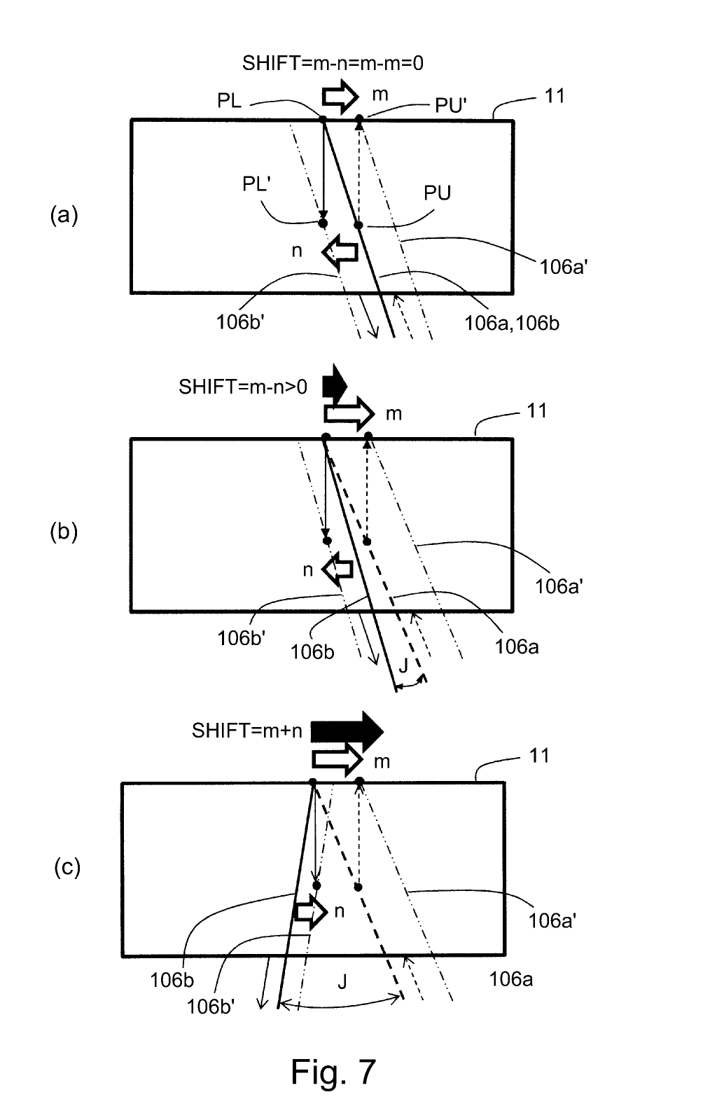

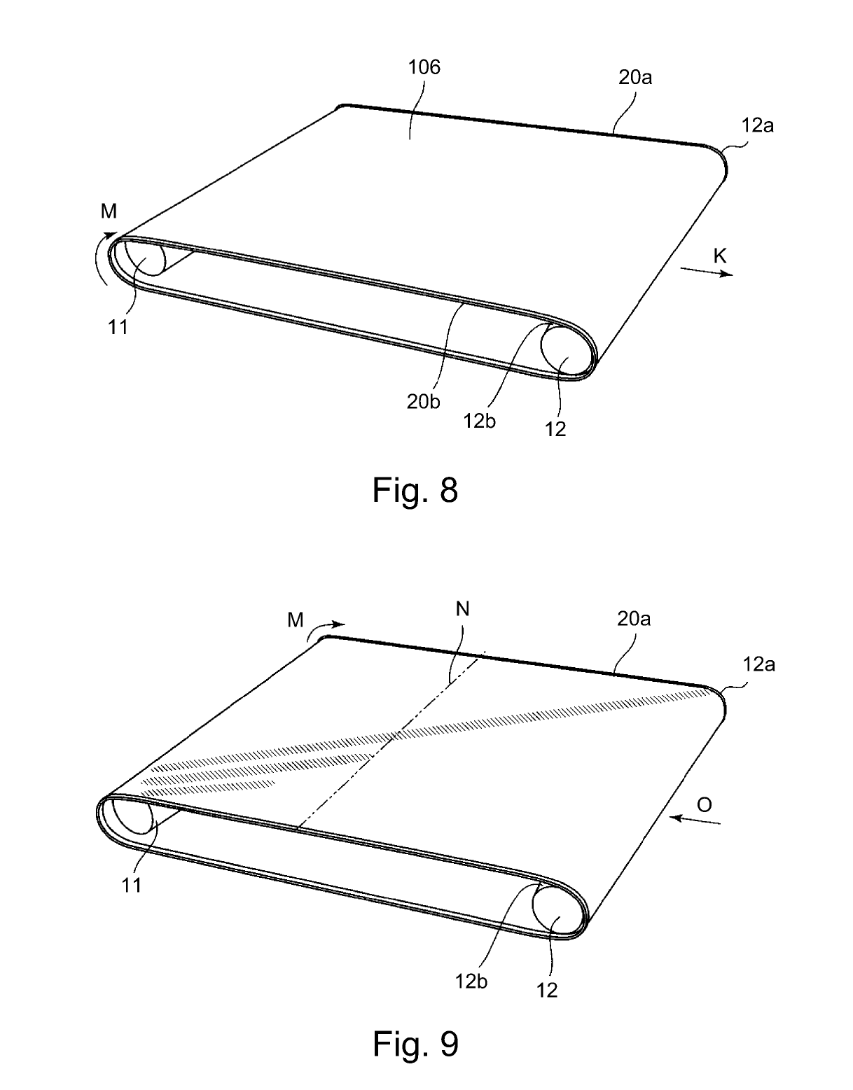

FIG. 8 shows a simulation model in the conventional example. This model is similar to a simulation model in this embodiment shown in FIG. 4 but the positions of the driving roller 11 and the tension roller 12 are changed to each other. That is, the tension roller 12 is provided with preventing portions 12a, 12b with respect to the rotational axis direction thereof, but the driving roller 11 is not provided with the portions 11a, 11b. The tension roller 12 is urged in an arrow K direction in FIG. 8 by springs (not shown) at the end portions thereof with respect to the rotational axis direction. A rear side rib 20a provided on the belt 106 in FIG. 8 is in a state in which the rib 20a runs on the preventing portion 12a. On the other hand, a front side rib 20b in FIG. 8 does not contact the preventing portion 12b of the tension roller 12. In this state, the driving roller 11 is rotated in an arrow M direction.

FIG. 9 shows a calculation result of a state of the surface of the belt 106 after the driving roller 11 is rotated by a predetermined distance in the conventional example. The surface of the belt 106 shown in FIG. 9 is that on a side downstream of the driving roller 11 in the case where the driving roller 11 is rotated in the arrow M direction in FIG. 9. The rear side rib 20a in FIG. 9 contacts the preventing portion 12a of the tension roller 12. Then, from this portion as a starting point, large waving (oblique line portions in FIG. 9) generates diagonally on the surface of the belt 106.

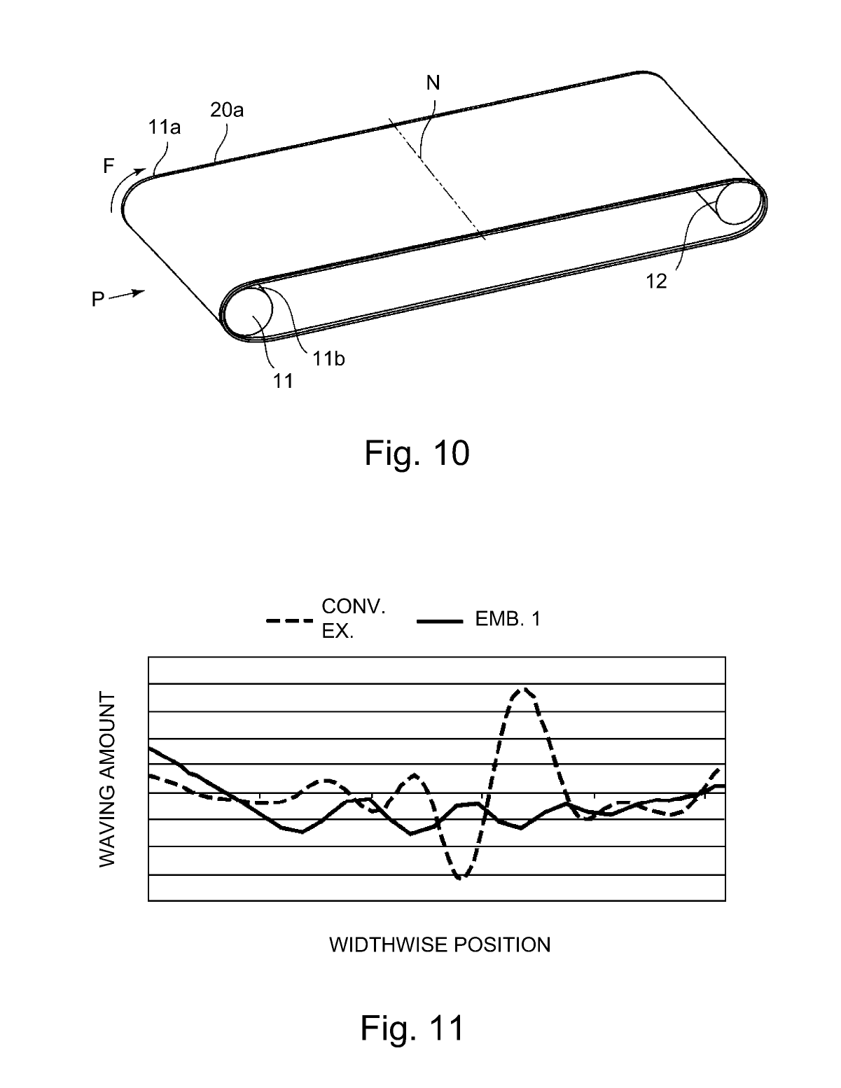

On the other hand, FIG. 10 shows a calculation result of a state of the surface of the belt 106 in a side downstream of the driving roller 11 similarly as in FIG. 9. The rear side rib 20a contacts the preventing portion 11a of the driving roller 11, but different from the conventional example, large waving is not observed.

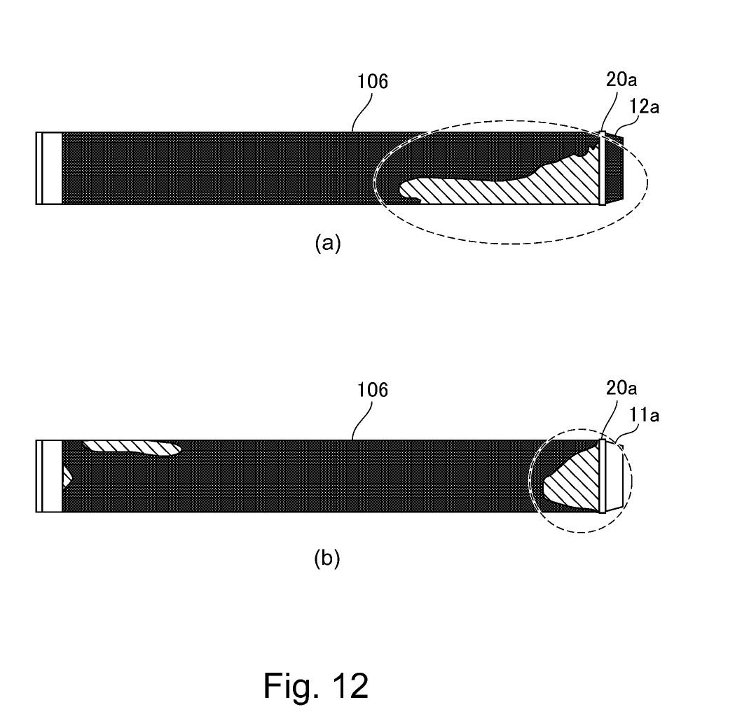

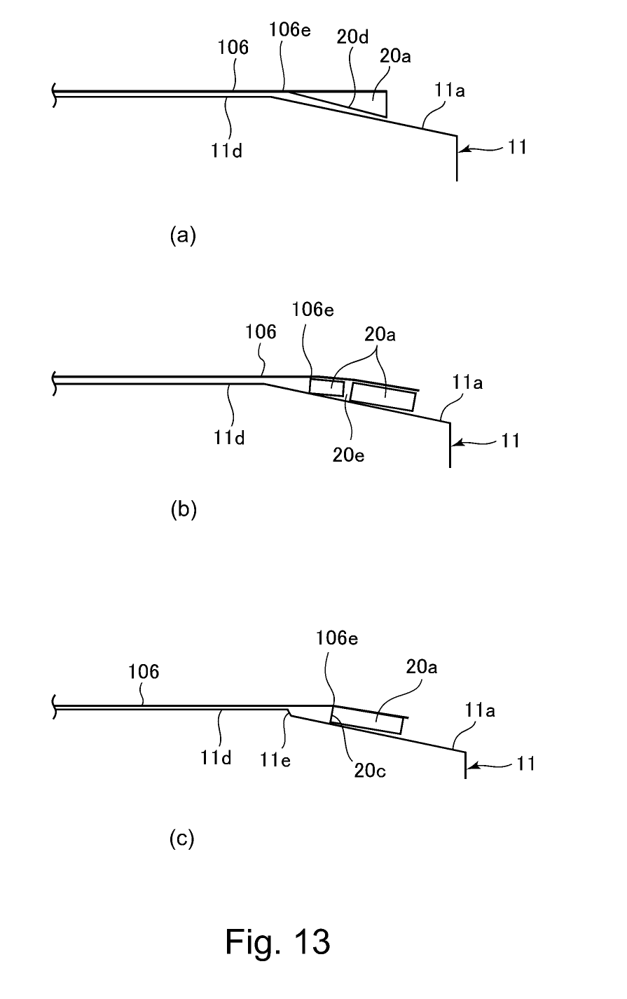

FIG. 11 is a graph showing shapes of waving on the surface (line N in FIGS. 9 and 10) of the belt 106 at a central portion between the driving roller 11 and the tension roller 12 on the downstream of the driving roller 11 in the conventional example (FIG. 9) and this embodiment (FIG. 10). In this embodiment, a waving amount is not more than ¼ of a waving amount in the conventional example. Accordingly, it is understood that compared with the conventional example, this embodiment is advantageous in terms of prevention of generation of an first defect such as transfer omission.

The reason why such a difference in waving amount generates will be described using (a) and (b) of FIG. 12. In FIG. 12, (a) is a schematic view, as seen in the arrow o direction in FIG. 9, of a calculation result of a simulation showing a contact status between the belt 106 and the tension roller 12 in the conventional example, and (b) is a schematic view, as seen in the arrow P direction in FIG. 10, of a calculation result of a simulation showing a contact status between the belt 106 and the driving roller 11 in this embodiment. In (a) and (b) of FIG. 12, a solid black portion is a contact region where the belt and the roller contact each other, and a hatched portion is a non-contact region where the belt and the roller are in non-contact with each other.

In either case of the conventional example and this embodiment, the non-contact region exists at the end portion, on the preventing portion 12a, 11a sides, where the rib 20a contacts the preventing portion with respect to the widthwise direction of the belt 106. However, as indicated by broken lines in (a) and (b) of FIG. 12, the non-contacting region in this embodiment is remarkably smaller than the non-contact region in the conventional example. This may be attributable to the following reason. In the conventional example, when the rib 20a contacts the tension roller 12, the end portion of the tension roller 12 on the contact side moves from an outer peripheral surface side toward an inner peripheral surface side of the belt 106, so that the tension roller 12 inclines. Then, in the neighborhood of the end portion of the tension roller 12 on the movement side, floating of the belt 106 from the tension roller 12 is promoted. In such a state, it would be considered that a retaining force of the belt 106 by the tension roller 12 on the contact side of the rib 20a with the preventing portion 12a weakens and thus large waving generates on the surface of the belt 106 from that portion as a starting point. On the other hand, in this embodiment, the driving roller 11 is provided with the preventing portion 11a, so that when the rib 20a runs on the preventing portion 11a, the driving roller 11 is prevented from inclining. For that reason, a degree of the floating of the belt 106 from the driving roller 11 is small, so that the waving of the surface of the belt 106 is suppressed.

As described above, according to this embodiment, in a constitution in which the shift of the belt 106 is prevented using the contact between the preventing portion and the preventing guide at the end portion of the belt 106 with respect to the widthwise direction, it is possible to suppress the waving of the belt 106.

### Embodiment 2

Another embodiment of the present invention will be described. Basic constitution and operation of an image forming apparatus in this embodiment are the same as those in Embodiment 1. Accordingly, elements having the same or corresponding functions and constitutions as those for the image forming apparatus in Embodiment 1 are represented by the same reference numerals or symbols, and will be omitted from detailed description.

In FIG. 13, (a), (b) and (c) are sectional views each showing the neighborhood of one end portion, corresponding to the enlarged portion of FIG. 3 in Embodiment 1, of the driving roller 11 with respect to the rotational axis direction. Incidentally, also in this embodiment, a constitution of the driving roller 11 in the neighborhood of the end portion relating to prevention of the shift of the belt 106 is substantially symmetrical with the constitution on the other side on the basis of a substantially center line of the belt 106 with respect to the widthwise direction.

In FIG. 13, (a) shows an example in which an inner peripheral surface 20d of a rib 20a inclines in the same direction as inclination of the preventing portion (tapered surface) 11a. That is, in the example of (a) of FIG. 13, the rib 20a has the inner peripheral surface 20d inclining in the same direction as inclination of the preventing portion 11a relative to an extension line of the portion (belt stretching portion) 11d of the driving roller 11 contacting the inner peripheral surface of the belt 106. Further, the inner peripheral surface 20d of the rib 20a contacts the preventing portion 11a. In the example shown in (a) of FIG. 13, a cross-sectional shape of the rib 20a along the widthwise direction of the belt 106 under no load is triangle but may also be trapezoidal. Further, in the example shown in (a) of FIG. 13, an inclination angle of the rib 20a is the same as an inclination angle of the preventing portion 11a, but may also be different from the inclination angle of the preventing portion 11a.

Next, in FIG. 13, (b) shows an example in which a rib is divided into two ribs 20a, 20e with respect to the widthwise direction of the belt 106 and in which the rib 20a closer to a central portion of the belt 106 with respect to the widthwise direction is smaller in width than the other rib 20a. In the example of (b) of FIG. 13, the number of the divider ribs 20a is two, but may also be three or more. Further, the ribs 20a, 20b may also be provided integrally with each other so that these ribs are divided using a slit 20e provided therebetween. That is, in the example of (b) of FIG. 13, the rib is divided into a plurality of portions with respect to the widthwise direction of the belt 106. Of these plurality of portions, at least one portion is narrower in width than at least another portion, with respect to the rotational axis direction of the driving roller 11, outside the above-mentioned at least one portion. Incidentally, the rib 20a having the inclined inner peripheral surface 20d as shown in (a) of FIG. 13 may also be divided into a plurality of portions.

Next, in FIG. 13, (c) shows an example in which a stepped portion 11e is provided between the preventing portion 11a and a portion (belt stretching portion) 11d of the driving roller 11 contacting the inner peripheral surface of the belt 106. That is, in the example of (c) of FIG. 13, between the preventing portion 11a and the portion (belt stretching portion) 11d of the driving roller 11 contacting the inner peripheral surface of the belt 106, the stepped portion 11e constituting an inside portion, with respect to a radial direction of the driving roller 11, where the preventing portion 11a is positioned inside the portion 11d.

By either of the constitutions shown in (a), (b) and (c) of FIG. 13, the following effect can be obtained. When the rib 20a run on the preventing portion 11a, a portion 106e, of the belt 106, corresponding to an end portion of the rib 20a toward a central side of the belt 106 with respect to the widthwise direction deforms in a direction of bending relative to the surface of the belt 106, so that it is possible to suppress an increases in stress exerted on the belt 106. As a result, further lifetime extension of the belt 106 can be realized. In the example of (a) of FIG. 13, the inner peripheral surface 20d of the rib 20a follows the inclination of the preventing portion 11a, so that bending deformation of the belt 106 can be suppressed. In the example of (b) of FIG. 13, the width of the rib 20a toward the central portion of the belt 106 with respect to the widthwise direction is small (narrow), and therefore the portion of the rib 20a easily causes compression deformation, so that the bending deformation of the belt 106 is suppressed. In the example of (c) of FIG. 13, the preventing portion 11a is disposed below the belt stretching portion 11d of the driving roller 11 by the stepped portion 11e, so that the bending deformation of the belt 106 is suppressed.

Further, in the example of (c) of FIG. 13, in the case where abnormal shift of the belt 106 generates, a side surface 20c, of the rib 20a, positioned on a central portion side of the belt 106 with respect to the widthwise direction contacts the stepped portion 11e of the driving roller 11, so that also an effect of suppressing further running-on of the rib 20a can be obtained.

### Other Embodiments

The present invention was described above based on the specific embodiments, but is not limited to the above-described embodiments.

In the above-described embodiments, the case where the endless belt is the intermediary transfer member was described, but the present invention is not limited thereto. The endless belt may also be a photosensitive belt or a transfer material feeding belt. The photosensitive belt is an example of a feeding member for carrying and feeding the toner image. The transfer feeding belt is an example of a feeding member for carrying and feeding the transfer material on which the toner image is formed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-087961 filed on Apr. 22, 2015, which is hereby incorporated by reference herein in its entirety.

What is claimed is:

1. A belt feeding device for an image forming apparatus, comprising:
a movable endless belt, including a preventing guide, configured to carry and feed a toner image or configured to carry and feed a recording material on which the toner image is formed,
wherein said preventing guide is provided through one-full circumference at each of end portions of said belt with respect to a widthwise direction perpendicular to a movement direction of said belt, and
a plurality of rotatable rollers, including a driving roller and a tension roller, configured to stretch said belt from an inner peripheral surface side,
wherein said driving roller moves said belt by being rotationally driven about a rotational axis of which direction is fixed, and includes a tapered portion, at each of end portions thereof with respect to a rotational axis direction, which narrows in diameter from a central portion toward the end portion with respect to the rotational axis direction and which contacts said preventing guide, and
wherein said tension roller rotates about a swingable rotational axis and urges said belt from the inner peripheral surface side toward an outer peripheral surface side, and a length of said tension roller is set such said belt during traveling is prevented from contacting said preventing guide.

2. A belt feeding device according to claim 1, wherein when said driving roller is seen from a direction perpendicular to the rotational axis of said driving roller, an angle formed between the rotational axis and said tapered portion is set at 10° or more and 30° or less.

3. A belt feeding device according to claim 1, wherein when said driving roller is seen from a direction perpendicular to the rotational axis of said driving roller, an angle formed between the rotational axis and said tapered portion is set at 10° or more and 20° or less.

4. A belt feeding device according to claim 1, wherein said preventing guide has a contact surface substantially parallel to an inner peripheral surface of said belt, and at least one of said contact surface contacts said tapered portion.

5. A belt feeding device according to claim 4, wherein said preventing guide has a side surface, substantially perpendicular to the inner peripheral surface of said belt, inside said belt with respect to the widthwise direction, and said side surface does not contact said tapered portion.

6. A belt feeding device according to claim 1, wherein said preventing guide has a contact surface inclining in the same direction as an inclination direction of said tapered portion with respect to the rotational axis direction, and said contact surface contacts said tapered portion.

7. A belt feeding device according to claim 1, wherein said preventing guide is divided into a plurality of portions with respect to the widthwise direction of said belt, and with respect to the rotational axis direction of said driving roller, a part of said plurality of portions is smaller in width than another part, of said plurality of portions, positioned outside said part.

8. A belt feeding device according to claim 1, wherein between said tapered portion and a portion, of said driving roller, contacting an inner peripheral surface of said belt, a stepped portion is provided so that said tapered portion is positioned inside said stepped portion with respect to a radial direction of said driving roller.

9. A belt feeding device according to claim 1, wherein said tapered portion is rotatable integrally with said driving roller.

10. A belt feeding device according to claim 1, wherein said tapered portion is rotatable independently of said driving roller.

11. An image forming apparatus comprising:
a toner image forming unit configured to form a toner image;
a movable endless belt, including a preventing guide, which is a feeding member configured to carry and feed the toner image formed by said toner image forming unit or configured to carry and feed a recording material on which the toner image is formed by said toner image forming unit,
wherein said preventing guide is provided through one-full circumference at each of end portions of said belt with respect to a widthwise direction perpendicular to a movement direction of said belt, and
a plurality of rotatable rollers, including a driving roller and a tension roller, configured to stretch said belt from an inner peripheral surface side,
wherein said driving roller moves said belt by being rotationally driven about a rotational axis of which direction is fixed, and includes a tapered portion, at each of end portions thereof with respect to a rotational axis direction, which narrows in diameter from a central portion toward the end portion with respect to the rotational axis direction and which contacts said preventing guide, and
wherein said tension roller rotates about a swingable rotational axis and urges said belt from the inner peripheral surface side toward an outer peripheral surface side, and a length of said tension roller is set such said belt during traveling is prevented from contacting said preventing guide.
